(19) United States
(12) Patent Application Publication
(10) Pub. No.: US 2024/0165889 A1
(43) Pub. Date: May 23, 2024

(54) POST-PROCESSING OF ADDITIVELY MANUFACTURED OBJECTS WITH COOLANTS

(71) Applicant: Align Technology, Inc., San Jose, CA (US)

(72) Inventors: Umesh Upendra Choudhary, Scotts Valley, CA (US); Sudharshan Anandan, Sunnyvale, CA (US); Joanne L. Lee, San Jose, CA (US); Viswanath Meenakshisundaram, Santa Clara, CA (US)

(21) Appl. No.: 18/511,887

(22) Filed: Nov. 16, 2023

Related U.S. Application Data
(60) Provisional application No. 63/384,205, filed on Nov. 17, 2022.

(51) Int. Cl. B29C 64/40; A61C 7/08; A61C 7/10; B29C 35/16; B33Y 40/20; B33Y 80/00

(52) U.S. Cl. CPC B29C 64/40; A61C 7/08; A61C 7/10; B29C 35/16; B33Y 40/20; B33Y 80/00; B29C 2071/025

(57) ABSTRACT

Methods and systems for processing additively manufactured objects are provided. In some embodiments, a method includes receiving an object fabricated using an additive manufacturing process, the object including a functional portion and a plurality of support structures connecting the functional portion to a build platform. The method can include cooling the plurality of support structures using a coolant. The method can further include fracturing the plurality of support structures to separate the functional portion of the object from the build platform.

The present application claims the benefit of priority to U.S. Provisional Application No. 63/384,205, filed Nov. 17, 2022, which is incorporated by reference herein in its entirety.

### TECHNICAL FIELD

The present technology generally relates to additive manufacturing, and in particular, to post-processing of additively manufactured objects with coolants.

### BACKGROUND

Additive manufacturing encompasses a variety of technologies that involve building up 3D objects from multiple layers of material. In some instances, objects fabricated using conventional additive manufacturing systems incorporate sacrificial structures that provide mechanical support to the object during the printing process, but are not intended to be in the final product. Typically, the sacrificial structures are manually broken off or trimmed from the object after fabrication. The process of removing the sacrificial structures can be time-consuming and inefficient for large scale manufacturing, and can present a risk of damaging the object.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram providing a general overview of a method for fabricating and post-processing an additively manufactured object, in accordance with embodiments of the present technology.

FIG. 2 is a partially schematic diagram providing a general overview of an additive manufacturing process, in accordance with embodiments of the present technology.

FIG. 3 is a flow diagram illustrating a method for processing an additively manufactured object, in accordance with embodiments of the present technology.

FIG. 4A is a perspective view of a representative example of an additively manufactured object configured in accordance with embodiments of the present technology.

FIG. 4B is a perspective view of another representative example of an additively manufactured object configured in accordance with embodiments of the present technology.

FIG. 5A is a partially schematic side view of an additively manufactured object including a tapered support structure, in accordance with embodiments of the present technology.

FIG. 5B is a partially schematic side view of an additively manufactured object including a support structure with a notch, in accordance with embodiments of the present technology.

FIG. 5C is a partially schematic side view of an additively manufactured object including different materials, in accordance with embodiments of the present technology.

FIG. 5D is a partially schematic side view of another additively manufactured object including different materials, in accordance with embodiments of the present technology.

FIG. 5E is a partially schematic side view of yet another additively manufactured object including a support structure with a tapered region and a neck, in accordance with embodiments of the present technology.

FIG. 6A is a partially schematic side view of an additively manufactured object being cooled by partial immersion into a coolant, in accordance with embodiments of the present technology.

FIG. 6B is a partially schematic side view of an additively manufactured object being cooled by complete immersion into a coolant, in accordance with embodiments of the present technology.

FIG. 7A is a partially schematic side view of an additively manufactured object with a temperature gradient, in accordance with embodiments of the present technology.

FIG. 7B is a partially schematic side view of an additively manufactured object being heated with a heating element, in accordance with embodiments of the present technology.

FIG. 7C is a partially schematic side view of an additively manufactured object being heated with an inflatable heating element, in accordance with embodiments of the present technology.

FIG. 8 is a partially schematic illustration of a system for cooling an additively manufactured object, in accordance with embodiments of the present technology.

FIG. 9A illustrates a representative example of a tooth repositioning appliance configured in accordance with embodiments of the present technology.

FIG. 9B illustrates a tooth repositioning system including a plurality of appliances, in accordance with embodiments of the present technology.

FIG. 9C illustrates a method of orthodontic treatment using a plurality of appliances, in accordance with embodiments of the present technology.

FIG. 10 illustrates a method for designing an orthodontic appliance, in accordance with embodiments of the present technology.

FIG. 11 illustrates a method for digitally planning an orthodontic treatment and/or design or fabrication of an appliance, in accordance with embodiments of the present technology.

### DETAILED DESCRIPTION

The present technology relates to processing of additively manufactured objects. In some embodiments, for example, a method includes receiving an object fabricated using an additive manufacturing process, the object including a functional portion and a plurality of support structures connecting the functional portion to a build platform. The method can include cooling the plurality of support structures using a coolant (e.g., a cryogenic fluid), and fracturing the plurality of support structures to separate the functional portion of the object from the build platform. In some embodiments, the cooled support structures are more brittle than the functional portion of the object, and thus can be easily broken off with relatively little force compared to non-cooled support structures. Accordingly, the present technology can reduce the likelihood of damaging the object during the support removal process, and/or can be adapted for use with automated removal mechanisms to increase processing efficiency and scalability.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Overview of Additive Manufacturing Technology

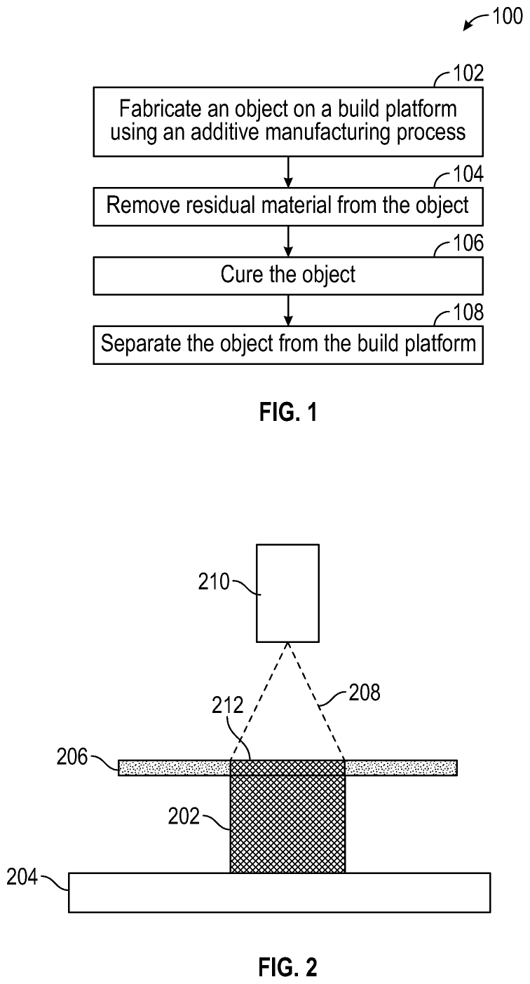

FIG. 1 is a flow diagram providing a general overview of a method 100 for fabricating and post-processing an additively manufactured object, in accordance with embodiments of the present technology. The method 100 can be used to produce many different types of additively manufactured objects, such as orthodontic appliances (e.g., aligners, palatal expanders, retainers, attachment placement devices, attachments), restorative objects (e.g., crowns, veneers, implants), and/or other dental appliances and devices (e.g., oral sleep apnea appliances, mouth guards). Additional examples of dental appliances and associated methods that are applicable to the present technology are described in Section III below.

The method 100 begins at block 102 with fabricating an object on a build platform using an additive manufacturing process. Additive manufacturing (also referred to herein as “3D printing”) includes a variety of technologies which fabricate 3D objects directly from digital models through an additive process. In some embodiments, additive manufacturing includes depositing a precursor material onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

The additive manufacturing process can implement any suitable technique known to those of skill in the art. Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° ° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s. 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,264 and U.S. Patent Publication No. 2014/0061974, the disclosures of which are incorporated herein by reference in their entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20°) C. or at an elevated temperature (e.g., a temperature within a range from 50° C. to 120°) C. When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

After the additively manufactured object is fabricated, the object can undergo one or more additional process steps, also referred to herein as “post-processing.” As described in detail below with respect to blocks 104-108, post-processing can include removing residual material from the object, curing the object, and/or separating the object from the build platform.

For example, at block 104, the method 100 continues with removing residual material from the object. The excess material can include excess precursor material (e.g., uncured resin) and/or other unwanted material (e.g., debris) that remains on or within the object after the additive manufacturing process. The residual material can be removed in many different ways, such as by exposing the object to a solvent (e.g., via spraying, immersion), heating or cooling the object, applying a vacuum to the object, blowing a pressurized gas onto the object, applying mechanical forces to the object (e.g., vibration, agitation, centrifugation, tumbling, brushing), and/or other suitable techniques. Optionally, the residual material can be collected and/or processed for reuse.

At block 106, the method 100 can optionally including curing the object. This additional curing step (also known as “post-curing”) can be used in situations where the object is still in a partially cured “green” state after fabrication. For example, the energy used to fabricate the object in block 102 may only partially polymerize the precursor material forming the object. Accordingly, the post-curing step may be needed to fully cure (e.g., fully polymerize) the object to its final, usable state. Post-curing can provide various benefits, such as improving the mechanical properties (e.g., stiffness, strength) and/or temperature stability of the object. Post-curing can be performed by heating the object, applying radiation (e.g., UV, visible, microwave) to the object, or suitable combinations thereof. In other embodiments, however, the post-curing process of block 106 is optional and can be omitted.

At block 108, the method 100 can include separating the object from the build platform. The build platform can mechanically support the object during fabrication and/or the post-processing steps described herein. In some embodiments, the object includes a functional portion that is intended to be in the final product, and a sacrificial portion (e.g., a raft and/or support structures) that is not intended to be in the final product. The sacrificial portion can temporarily connect the functional portion to the build platform during fabrication and post-processing. Accordingly, the process of block 108 can include fracturing the sacrificial portion to separate the functional portion of the object from the build platform. In some embodiments, the process of block 108 includes cooling the sacrificial portion to facilitate fracturing of the sacrificial portion, as described in Section II below.

The method 100 illustrated in FIG. 1 can be modified in many different ways. For example, although the above steps of the method 100 are described with respect to a single object, the method 100 can be used to sequentially or concurrently fabricate and post-process any suitable number of objects, such as tens, hundreds, or thousands of additively manufactured objects. As another example, the ordering of the processes shown in FIG. 1 can be varied (e.g., the process of block 108 can be performed before and/or concurrently with the processes of blocks 104 and/or 106). Some of the processes of the method 100 can be omitted, such as the process of block 106.

Additionally, the method 100 can include processes not shown in FIG. 1, such as cleaning the object (e.g., washing), annealing the object, trimming the object to remove structures that are not intended to be present in the final product (e.g., residual parts of the support structures), and/or packaging the object for shipment. Optionally, the method 100 can include modifying at least one surface of the object. The surface modifications can be applied to some or all of the surfaces of the object (e.g., the exterior and/or interior surfaces) to alter one or more surface characteristics, such as the surface finish (e.g., roughness, waviness, lay), porosity, visual appearance (e.g., gloss, transparency, visibility of print lines), hydrophobicity, and/or chemical reactivity. In some embodiments, the surface modifications include removing material from the object, e.g., by polishing, abrading, blasting, etc. Alternatively or in combination, the surface modifications can include applying an additional material to the object. For example, the additional material can be a coating, such as a polymeric coating. The coating can be applied to one or more surfaces of the object for various purposes, including, but not limited to: providing a smooth surface finish, which can be beneficial for aesthetics and/or to improve user comfort if the object is intended to be in contact with the user's body (e.g., an orthodontic appliance worn on the teeth); coloring and/or applying other aesthetic features to the object; improving scratch resistance and/or other mechanical properties; providing antimicrobial properties; and incorporating therapeutic agents into the object for controlled release.

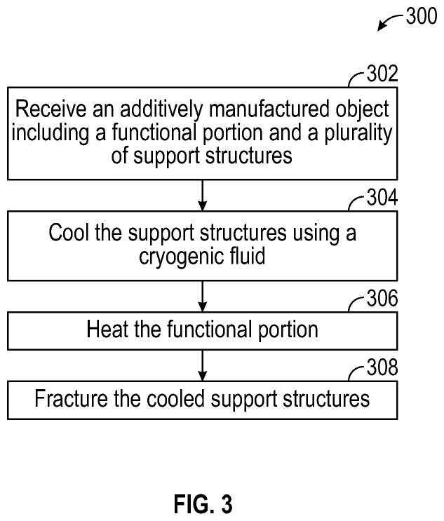

FIG. 2 is a partially schematic diagram providing a general overview of an additive manufacturing process, in accordance with embodiments of the present technology. In the illustrated embodiment, an object 202 is fabricated on a build platform 204 from a series of cured material layers, with each layer having a geometry corresponding to a respective cross-section of the object 202. To fabricate an individual object layer, a layer of curable material 206 (e.g., polymerizable resin) is brought into contact with the build platform 204 (when fabricating the first layer of the object 202) or with the previously formed portion of the object 202 on the build platform 204 (when fabricating subsequent layers of the object 202). In some embodiments, the curable material 206 is formed on and supported by a substrate (not shown), such as a film. Energy 208 (e.g., light) from an energy source 210 (e.g., a laser, projector, or light engine) is then applied to the curable material 206 to form a cured material layer 212 on the build platform 204 or on the object 202. The remaining curable material 206 can then be moved away from the build platform 204 (e.g., by lowering the build platform 204, by moving the build platform 204 laterally, by raising the curable material 206, and/or by moving the curable material 206 laterally), thus leaving the cured material layer 212 in place on the build platform 204 and/or object 202. The fabrication process can then be repeated with a fresh layer of curable material 206 to build up the next layer of the object 202.

The illustrated embodiment shows a “top down” configuration in which the energy source 210 is positioned above and directs the energy 208 down toward the build platform 204, such that the object 202 is formed on the upper surface of the build platform 204. Accordingly, the build platform 204 can be incrementally lowered relative to the energy source 210 as successive layers of the object 202 are formed. In other embodiments, however, the additive manufacturing process of FIG. 2 can be performed using a “bottom up” configuration in which the energy source 210 is positioned below and directs the energy 208 up toward the build platform 204, such that the object 202 is formed on the lower surface of the build platform 204. Accordingly, the build platform 204 can be incrementally raised relative to the energy source 210 as successive layers of the object 202 are formed.

Although FIG. 2 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

II. Post-Processing of Additively Manufactured Objects with Coolants

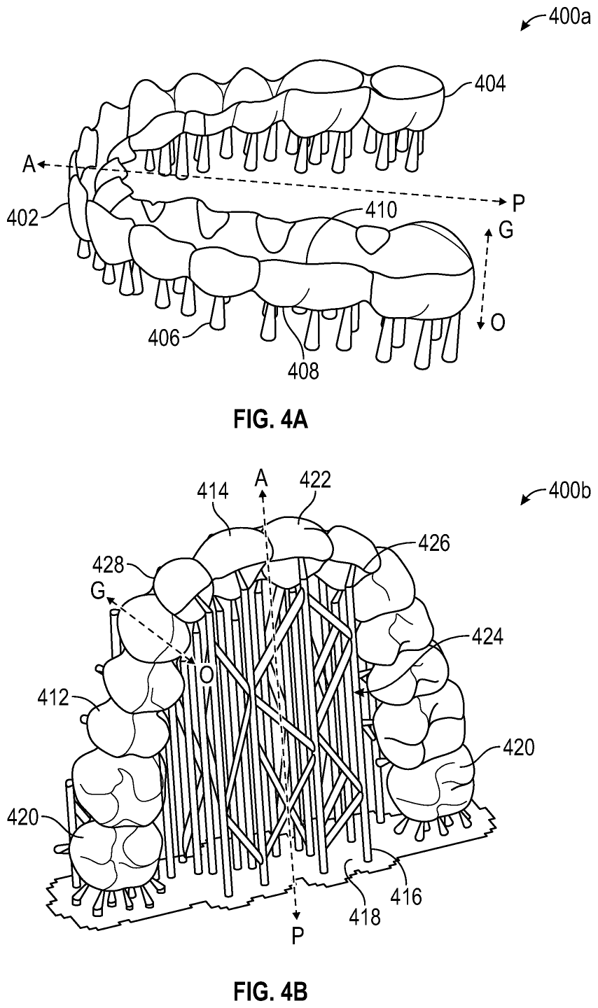

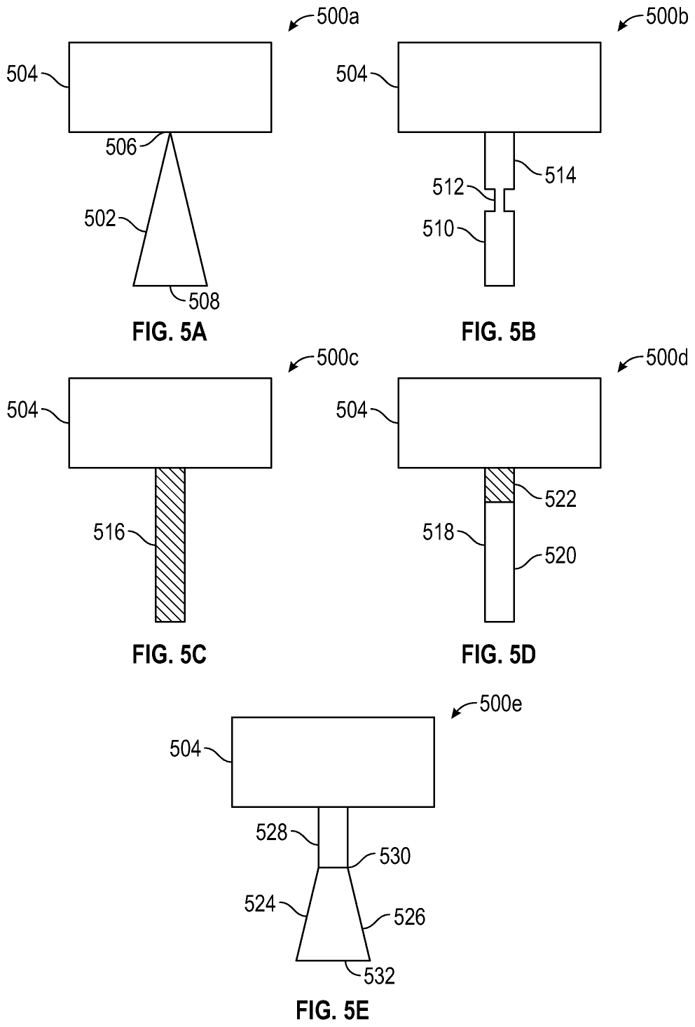

FIG. 3 is a flow diagram illustrating a method 300 for processing an additively manufactured object, in accordance with embodiments of the present technology. The method 300 can be performed using any suitable system or device, such as any of the embodiments described herein in connection with FIGS. 4A-8. In some embodiments, some or all of the processes of the method 300 are implemented as computer-readable instructions (e.g., program code) that are configured to be executed by one or more processors of a computing device. The method 300 can be combined with any of the other methods described herein, such as the method 100 of FIG. 1. For example, the method 300 can be performed as part of the process of block 108 of FIG. 1.

The method 300 begins at block 302 with receiving an additively manufactured object. The object can be fabricated using any of the additive manufacturing techniques described herein, and can be made from any suitable material or combination of materials. The object can include a functional portion and a plurality of support structures (e.g., struts, pillars, cones, lattices). As described above, the functional portion can remain part of the object after post-processing is completed, while the support structures can be sacrificial components that are partially or completely removed during post-processing. The support structures can connect the functional portion of the object to a build platform (e.g., a printer bed, tray, plate, film, sheet, or other planar substrate) that supports the object during additive manufacturing and/or post-processing. The support structures can be formed directly on the build platform, or can be formed on another sacrificial portion of the object that is connected to the build platform (e.g., a flattened raft, layer, film mesh, grid, etc., having a large surface area to improve adhesion to the build platform). The support structures can extend vertically above the surface of the build platform to connect to and provide support for the functional portion of the object. Support structures may be beneficial or necessary if the object includes unstable structures that would collapse without additional stabilization, such as overhangs, bridges, islands, valleys, etc. The locations and geometry (e.g., size, shape, density) of the support structures can be selected based on the geometry of the object.

FIG. 4A is a perspective view of a representative example of an additively manufactured object 400a configured in accordance with embodiments of the present technology. The object 400a includes a functional portion 402 configured as a dental appliance 404 intended to be worn on a patient's teeth. In the illustrated embodiment, the dental appliance 404 is an aligner having a shell with a plurality of teeth-receiving cavities that reposition the patient's teeth. In other embodiments, the dental appliance 404 can be another type of appliance, such as a palatal expander, attachment placement device, mouthguard, sleep apnea device, etc.

The object 400a includes a plurality of support structures 406 connecting the dental appliance 404 to the surface of a build platform (not shown). In the illustrated embodiment, the support structures 406 have a conical shape, with the base of the cone being attached to the build platform (or to a raft formed on the build platform—not shown), and the apex of the cone being attached to the dental appliance 404. As shown in FIG. 4A, the dental appliance 404 can be in a horizontal orientation, such that the anterior-posterior axis of the dental appliance 404 (axis A-P) is substantially parallel to the surface of the build platform and/or the occlusal-gingival axis of the dental appliance 404 (axis O-G) is substantially orthogonal to the surface of the build platform. Additionally, the occlusal surfaces 408 of the dental appliance 404 can be oriented toward the surface of the build platform and connected to the support structures 406, while the gingival edges 410 and teeth-receiving cavities of the dental appliance 404 are oriented away from the build platform. In other embodiments, the dental appliance 404 can be oriented differently. For example, the dental appliance 404 can be tilted so that the anterior-posterior axis is not parallel to the surface of the build platform (e.g., at an angle of at least 2°, 5°, 10°, 15°, 20°, 30°, 40°, 45°, 50°, 60°, 70°, or 80° relative to the surface of the build platform). Alternatively or in combination, the dental appliance 404 can be flipped so that the gingival edges 410 are oriented toward the build platform and connected to the support structures 406, while the occlusal surfaces 408 are oriented away from the build platform.

FIG. 4B is a perspective view of another representative example of an additively manufactured object 400b configured in accordance with embodiments of the present technology. The object 400b includes a functional portion 412 configured as a dental appliance 414 (e.g., an aligner), and a plurality of support structures 416 connecting the dental appliance 414 to a build and/or lattices that are formed on a raft 418, and the raft 418 is attached to the build platform. In other embodiments, the raft 418 can be omitted and the support structures 416 can be directly attached to the build platform.

As shown in FIG. 4B, the dental appliance 414 can be in a vertical orientation, such that the anterior-posterior axis of the dental appliance 414 (axis A-P) is substantially orthogonal to the surface of the build platform and/or the occlusal-gingival axis of the dental appliance 414 (axis O-G) is substantially parallel to the surface of the build platform. Additionally, the posterior regions 420 of the dental appliance 414 can be oriented toward the surface of the build platform and connected to the support structures 416, while the anterior region 422 of the dental appliance 414 are oriented away from the build platform. Optionally, the support structures 416 can also be located within or proximate to the lingual space 424 defined by the arch of the dental appliance 414, and can connect to the occlusal surfaces 426 and/or gingival edges 428 of the dental appliance 414.

In other embodiments, the dental appliance 414 can be oriented differently. For example, the dental appliance 414 can be tilted so that the anterior-posterior axis is not orthogonal to the surface of the build platform (e.g., at an angle of no more than 85°, 80°, 70°, 60°, 50°, 45°, 30°, 20°, or 10° relative to the surface of the build platform). Alternatively or in combination, the dental appliance 414 can be flipped so that the anterior region 422 is oriented toward the build platform and connected to the support structures 416, while the posterior regions 420 are oriented away from the build platform.

Referring again to FIG. 3, at block 304, the method 300 continues with cooling the support structures using a coolant. The coolant can be a substance (e.g., a liquid or gas) having a temperature less than or equal to 0° C., −10° C., −20° C., −30° C., −40° C., −50° C., −75° C., −100° C., −125° C., −150° C., −175° C., or −200° C.; and/or within a range from −0° C. to −200° C., −50° C. to −200° C., −100° C. to −150° C., or −150° C. to −200° C. In some embodiments, the coolant is a cryogenic fluid. Examples of cryogenic fluids that can be used include, but are not limited to, liquid nitrogen, sublimated dry ice, liquid carbon dioxide, liquid oxygen, or liquid helium, or suitable combinations thereof. In other embodiments, the coolant can be a non-cryogenic fluid.

In some embodiments, the support structures are cooled by the coolant to a temperature below room temperature, such as a temperature less than or equal to 10° C., 0° C., −10° C., −20° C., −30° C., −40° C., −50° C., −75° C., −100° C., −125° C., −150° C., −175° C., or −200° C.; and/or within a range from 0° C. to −200° C., −50° C. to −150° C., −50° C. to −100° C., or −100° C. to −200° C. Optionally, the support structures can be made partially or completely out of a material (e.g., a polymeric material, such as a thermoset or thermoplastic polymer) having a glass transition temperature (Tg), and the coolant can cool the support structures to a temperature below the Tg of the material. For example, the Tg of the material of the support structures can be at least −100° C., −90° C.-80° C., −70° C., −60° C., −50° C., −30° C., −40° C., −20° C., −10° C., 0° C., 10° C., 20° C., 30° C., 40° C., 50° C., 60° C., 70° C., 80° C., 90° C., 100° C., 120° C., 150° C., or 200° C.; and/or within a range from −100° C. to 200° ° C., −100° C. to 0° C., −50° C. to 50° C., 0° C. to 100° C., or 50° C. to 200° C. The coolant can cool the support structures to a temperature that is at least 10° C., 20° C., 30° C., 40° C., 50° C., 75° C., or 100° C. below the Tg of the material of the support structures. When cooled, the support structures can exhibit increased brittleness, thus reducing the amount of force needed to fracture the support structures. For example, the cooled support structures can exhibit an elongation at break that is less than or equal to 10%, 5%, 4%, 3%, 2%, 1%, or 0%.

After cooling, the support structures can be more brittle than the rest of the object (e.g., the functional portion of the object), such that the object preferentially fractures at the support structures. The geometry and/or properties of the support structures can be configured to facilitate brittle fracture at the support structures, rather than at the functional portion of the object. For example, the support structures can be thinner than the functional portion of the object. In some embodiments, the support structures have a maximum cross-sectional dimension (e.g., width and/or diameter) less than or equal to 5 mm, 2 mm, 1 mm, 0.75 mm, 0.5 mm, 0.25 mm, or 0.1 mm.

Optionally, the support structures can include at least one narrowed region that preferentially fractures when a force is applied to the object, e.g., due to increased brittleness and/or stress concentration at the narrowed region. The narrowed region can have a reduced cross-sectional dimension (e.g., width and/or diameter) compared to the remaining regions of the support structure. For example, the cross-sectional dimension of the narrowed region can be less than or equal to 2 mm, 1 mm, 0.75 mm, 0.5 mm, 0.25 mm, or 0.1 mm. The narrowed region can be located at any position along the support structure, such as at or proximate to the attachment point to the functional portion of the object.

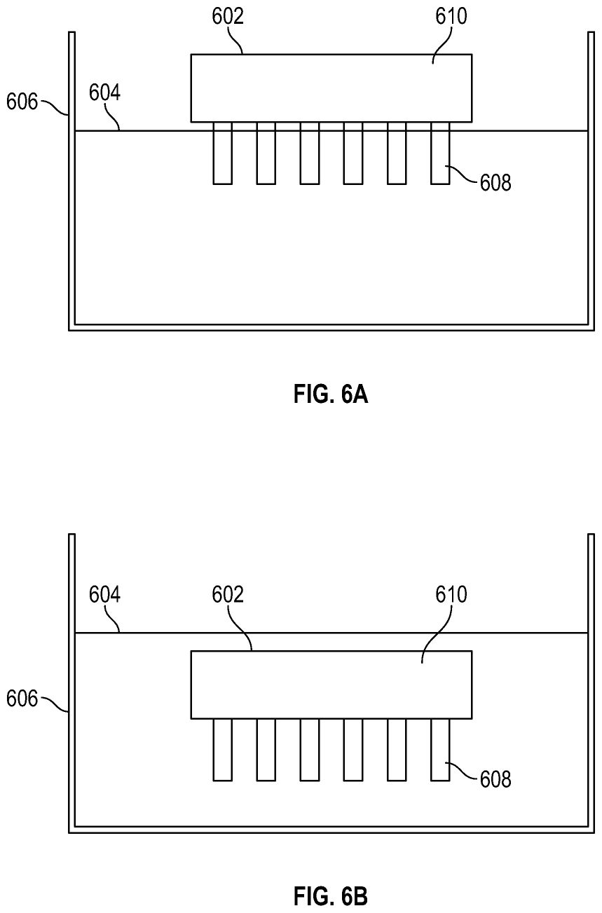

FIGS. 5A-5E illustrate representative examples of objects with support structures that may be used in the present technology. Any of the features of the embodiments of FIGS. 5A-5E can be combined with each other and/or with features of any of the other embodiments described herein (e.g., the embodiments of FIGS. 4A and 4B).

FIG. 5A is a partially schematic side view of an object 500a including a tapered support structure 502, in accordance with embodiments of the present technology. The tapered support structure 502 can have a conical or truncated conical shape, with a narrower apex 506 of the cone being connected to and/or proximate to the functional portion 504 of the object 500a, and a wider base 508 of the cone being spaced apart from the functional portion 504. Accordingly, when a force is applied to the object 500a (e.g., to the support structure 502, the functional portion 504, or both), the resulting stress can be concentrated at or near the apex 506, thus causing the support structure 502 to preferentially fracture at or near the apex 506.

As another example, FIG. 5B is a partially schematic side view of an object 500b including a support structure 510 with a notch 512, in accordance with embodiments of the present technology. The notch 512 can be a groove, recess, indentation, cavity, perforation, etc., that extends partially or entirely around the perimeter (e.g., circumference) of the support structure 510. Accordingly, the notch 512 can form a narrowed region in the support structure 510 that preferentially fractures when a force is applied to the object 500b. In the illustrated embodiment, the narrowed region with the notch 512 is spaced apart from the functional portion 504 of the object 500b by a widened region 514 of the support structure 510. In other embodiments, however, the narrowed region with the notch 512 can be adjacent to and/or connected to the functional portion 504 of the object 500b.

In some embodiments, the support structures described herein are made out of the same material as the functional portion of the object. Alternatively, the support structures described herein can be made partially or entirely out of a first material that becomes more brittle when cooled, while the functional portion of the object can be made out of a second material that is less brittle than the first material when cooled. For example, the first material can have a first Tg, and the second material can have a second, lower Tg. The first Tg can be at least 10° C., 20° C., 30° C., 40° C. 50° C., or 100° C. higher than the second Tg. Accordingly, when a force is applied to the object after cooling, the object can preferentially fracture at the support structures while leaving the functional portion intact.

FIG. 5C is a partially schematic side view of an object 500c including different materials, in accordance with embodiments of the present technology. Specifically, the functional portion 504 can be made out of a first material that is less susceptible to fracturing when cooled (e.g., a low Tg material), and the support structure 516 can be made out of a second material that is more susceptible to fracturing when cooled (e.g., a high Tg material). In the illustrated embodiment, the entire support structure 516 is made out of the second material. Accordingly, after cooling, a force applied to the object 500c (to the support structure 516 and/or to the functional portion 504) can cause the support structure 516 to fracture while leaving the functional portion 504 substantially unaffected.

FIG. 5D is a partially schematic side view of another object 500d including different materials, in accordance with embodiments of the present technology. The object 500d includes a functional portion 504 made out of a first material that is less susceptible to fracturing when cooled (e.g., a low Tg material). The object 500d also includes a support structure 518 including a first region 520 made out of the first material, and a second region 522 made out of a second material that is more susceptible to fracturing when cooled (e.g., a high Tg material). In the illustrated embodiment, the second region 522 is adjacent to the functional portion 504, such that the support structure 518 is designed to fracture at or proximate to the connection point to the functional portion 504. In other embodiments, however, the second region 522 can be spaced apart from the functional portion 504, e.g., by a third region made of the first material or another material (e.g., another material that is less susceptible to fracturing when cooled than the second material).

FIG. 5E is a partially schematic side view of an object 500e including a support structure 524 with a tapered region 526 and a neck 528, in accordance with embodiments of the present technology. In the illustrated embodiment, the neck 528 is connected to and adjacent to the functional portion 504 of the object 500e, and the tapered region 526 is connected to the neck 528 and spaced apart from the functional portion 504. The tapered region 526 can have a conical or truncated conical shape, with a narrower apex 530 of the tapered region 526 being connected to and/or proximate to the neck 528, and a wider base 532 of the tapered region 526 being spaced apart from the functional portion 504. The neck 528 can have a cylindrical, cuboidal, or other elongate shape. Similar to the notch 512 of FIG. 5B, the neck 528 can form a narrowed region that preferentially fractures when a force is applied to the object 500e. For instance, the neck 528 can have a width and/or diameter that is smaller than the width and/or diameter of the tapered region 526 (e.g., of the apex 530 and/or the base 532 of the tapered region 526). Optionally, the neck 528 can be made out of a different material than the functional portion 502 and/or the tapered region 526, such as a material that is more susceptible to fracturing when cooled (e.g., a high Tg material).

Referring again to FIG. 3, the cooling process of block 304 can be performed in many different ways, such as by immersing the object in the coolant, applying the coolant onto the object (e.g., by jetting, spraying, pouring, or flowing the coolant onto the object), using the coolant to cool an environment surrounding the object, using the coolant to cool another device (e.g., a heat sink) that is thermally coupled to the object, or suitable combinations thereof. The cooling process of block 304 can include cooling the support structures only, or can include cooling the entire object (e.g., cooling the support structures and the functional portion simultaneously). In some embodiments, all of the support structures are cooled, while in other embodiments, only some of the support structures are cooled (e.g., at least 50%, 75%, 80%, 90%, or 95% of the support structures).

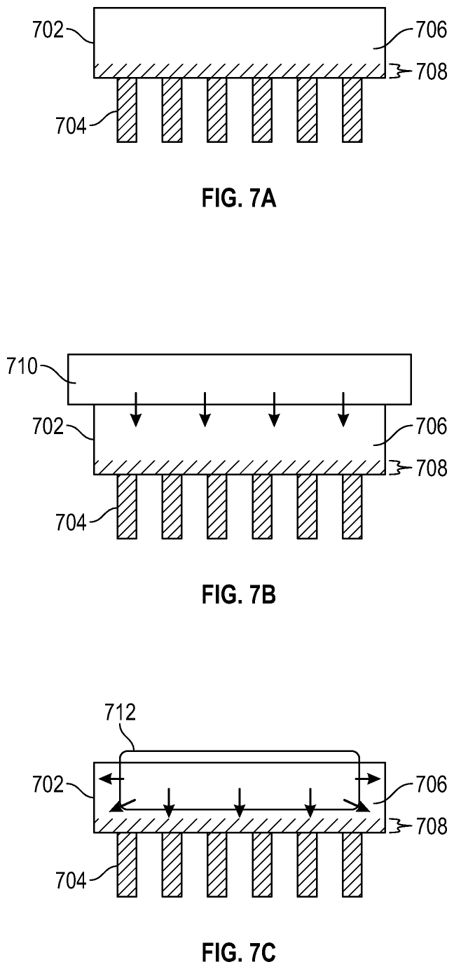

For example, FIGS. 6A and 6B are partially schematic side views of an object 602 being cooled by immersion in a coolant 604, in accordance with embodiments of the present technology. Referring first to FIG. 6A, the object 602 can be immersed into a coolant 604 within a container 606 (e.g., a vat, reservoir, chamber, tank). The object 602 can remain immersed in the coolant 604 for a sufficiently long time period for the support structures 608 to reach a target cooled temperature. For example, the time period can be at least 10 seconds, 20 second, 30 seconds, 1 minute, 2 minutes, 3 minutes, 4 minutes, 5 minutes, or 10 minutes; and/or no more than 5 minutes, 4 minutes, 3 minutes, 2 minutes, 1 minute, or 30 seconds. The object 602 can then be removed from the coolant 604 and a force can be applied to fracture the support structures 608, as described further below.

In the illustrated embodiment, only the support structures 608 of the object 602 are immersed into and directly exposed to the coolant 604, while the rest of the object 602 (e.g., the functional portion 610) is not immersed into the coolant 604. Accordingly, the support structures 608 can be cooled to a lower temperature than the functional portion 610, thus creating a temperature gradient in the object 602, as described further below. In some embodiments, only part of each support structure 608 is immersed in the coolant 604 (e.g., the parts of the support structure 608 spaced apart from the functional portion 610), while in other embodiments, the entirety of each support structure 608 is immersed in the coolant 604. The functional portion 610 can remain entirely outside of the coolant 604, or the functional portion 610 can also be partially immersed in the coolant 604. For example, the parts of the functional portion 610 that are connected to and/or immediately adjacent to the support structures 608 can also be immersed in the coolant 604 together with the support structures 608.

In some embodiments, the object 602 is supported by a carrier (e.g., a frame, movable platform, clamp, holder, gripper, robotic arm—not shown) that immerses the object 602 into the coolant 604 in an automated or semi-automated manner. The carrier can be coupled directly to the object 602, or the carrier can be coupled to the build platform (not shown) supporting the object 602. The carrier can be an actuatable device that controls the position and/or orientation of the object 602 relative to the coolant 604. For example, the object 602 can be mounted to the carrier with the support structures 608 oriented toward the coolant 604, and the functional portion 610 oriented away from the coolant 604. Alternatively, the carrier can rotate the object 602 from an initial orientation into an orientation with the support structures 608 facing the coolant 604. The carrier can then lower the object 602 to a desired depth into the coolant 604, such as a depth in which the support structures 608 are partially or completely immersed, while the functional portion 610 remains partially or completely outside of the coolant 604. Optionally, the carrier can rotate and/or translate the object 602 so that different subsets of the support structures 608 are immersed in the coolant 604 at different times. This approach can be advantageous in embodiments where it is difficult or impossible to submerge all of the support structures 608 in the coolant 604 at once. The carrier can hold the object 602 in the coolant 604 for a desired time period, and can then raise the object 602 out of the coolant 604 when the time period has elapsed.

Optionally, the operation of the carrier can be controlled based on feedback from one or more sensors, such as temperature sensors (e.g., thermocouples, thermistors, infrared cameras), position sensors, orientation sensors, motion sensors (e.g., accelerometers, gyroscopes), optical sensors, imaging devices (e.g., cameras, scanners), etc. For example, the sensor(s) can generate image data of the object 602, and the image data can be analyzed (e.g., using computer vision and/or machine learning algorithms) to identify the locations of the support structures 608 in the object 602. Based on the location information, the carrier can immerse the support structures 608 in the coolant 604, while keeping the functional portion 610 partially or entirely out of the coolant 604. As another example, the sensor(s) can monitor a temperature of the object 602, such as the temperature of the support structures 608 and/or functional portion 610. The carrier can automatically raise the object 602 when the support structures 608 reach a desired cooling temperature and/or to prevent the functional portion 610 from being cooled below a predetermined threshold temperature (e.g., a temperature that may damage to the functional portion 610 and/or make the functional portion 610 too brittle for subsequent processing).

Referring next to FIG. 6B, in other embodiments, the entire object 602 can be immersed in the coolant 604, such that both the support structures 608 and the functional portion 610 of the object 602 are directly exposed to the coolant 604. In such embodiments, the support structures 608 and the functional portion 610 can both be cooled to the same temperature. Alternatively, the functional portion 610 can be maintained at higher temperature than the support structures 608, e.g., by heating and/or insulating the functional portion 610, as described further below. In some embodiments, the object 602 is immersed into the coolant 604 using an automated or semi-automated carrier, as described above in connection with FIG. 6A.

Referring again to FIG. 3, at block 306, the method 300 can optionally include heating the functional portion of the object. In some embodiments, the heating produces a temperature gradient in the object, such that the support structures of the object are at a lower temperature than the remaining portions of the object. This approach can be beneficial to ensure that the object fractures preferentially at the support structures and/or to avoid damage to the functional portion of the object during processing (e.g., if the functional portion would become too brittle if cooled to the same temperature as the support structures).

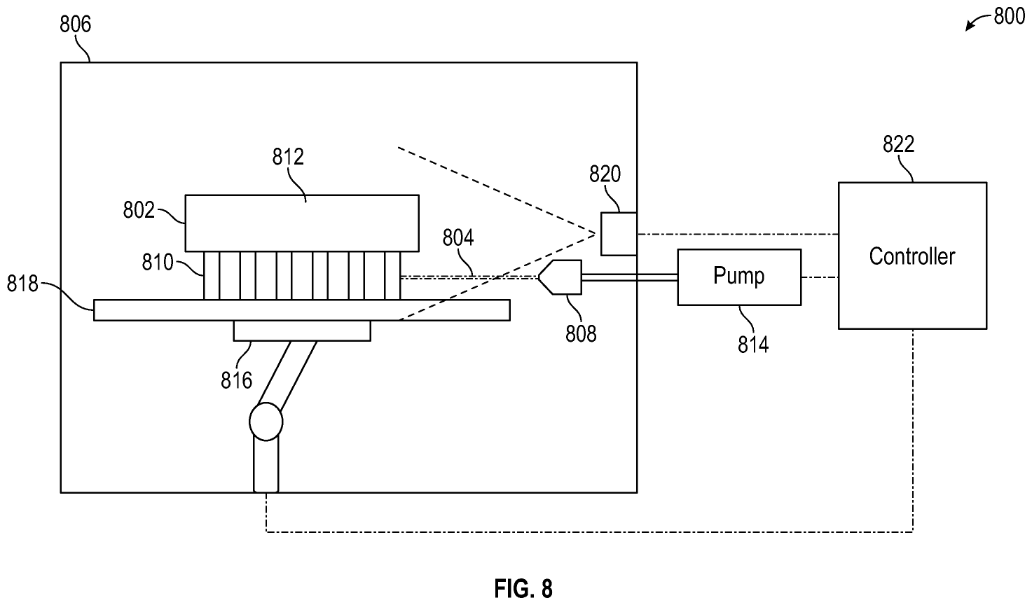

For example, FIG. 7A is a partially schematic side view of an object 702 with a temperature gradient. In the illustrated embodiment, the temperature gradient includes a first, lower temperature at the support structures 704 of the object 702, and a second, higher temperature at the functional portion 706 of the object 702. The first temperature can be less than or equal to 10° C., 0° C., −10° C., −20° C., −30° C., −40° C., −50° C., −75° C., −100° C., −125° C., −150° C., −175° C., or −200° C.; and/or within a range from 0° C. to −200° C., −50° C. to −150° C., −50° C. to −100° C., or −100° ° C. to −200° C. The second temperature can be greater than or equal to −50° C., −20° C., −10° C., 0° C. 10° C. 20° C., 25° C., 30° C., 40° C., or 50° C.; and/or within a range from −50° C. to 50° C., 0° C. to 50° C., or 20° C. to 30° C. In some embodiments, the second temperature is at least 5° C., 10° C. 20° C., 30° C., 40° C., 50° C. 75° C., or 100° C. higher than the first temperature. In embodiments where the support structures and functional portion are made out of one or more materials that exhibit glass transition behavior, the first temperature can be below the Tg of the support structures, and the second temperature can be above the Tg of the functional portion (which may or may not be the same as the Tg of the support structures).

Optionally, the temperature gradient can include at least one third temperature at an intermediate region 708 of the object 702 between the support structures 704 and the functional portion 706 of the object 702. As shown in FIG. 7A, the intermediate region 708 can include the section of the functional portion 706 that is adjacent to the support structures 704. Alternatively or in combination, the intermediate region 708 can include the sections of the support structures 704 that are adjacent to the functional portion 706. The third temperature of the intermediate region 708 can be between the first and second temperatures, such that the intermediate region 708 provides a gradual transition in temperature from the support structures 704 to the functional portion 706. In other embodiments, however, the temperature profile can change abruptly from the first temperature of the support structures 704 to the second temperature of the functional portion 706, with no intermediate third temperature.

The temperature gradient illustrated in FIG. 7A can be produced in many different ways. For example, referring to FIG. 7B, the temperature gradient can be produced by heating the functional portion 706 using a heating element 710, in accordance with embodiments of the present technology. The heating element 710 (e.g., a heating plate, thermoelectric heater) can be placed into direct contact with the functional portion 706 to transfer thermal energy to the functional portion 706. Although FIG. 7B illustrates a single heating element 710, in other embodiments, multiple heating elements 710 can be applied to different regions of the functional portion 706 to produce localized heating of each region. The number and arrangement of the heating elements 710 can be configured based on the geometry of the object 702.

FIG. 7C illustrates producing a temperature gradient using an inflatable heating element 712, in accordance with embodiments of the present technology. The inflatable heating element 712 can be used in embodiments where the functional portion 706 of the object 702 includes an accessible interior space (e.g., a cavity, recess, opening, aperture, indentation). For example, the inflatable heating element 712 can be used to heat a dental appliance including a plurality of teeth-receiving cavities. The inflatable heating element 712 can be inserted partially or entirely into the interior space in a low-profile (e.g., deflated) state. Subsequently, the inflatable heating element 712 can be filled with a heated fluid (e.g., heated air or water) to transition the inflatable heating element 712 into an expanded (e.g., inflated) state and to heat the functional portion 706. The inflatable heating element 712 can be made out of a flexible material such that when expanded, the inflatable heating element 712 conforms to the geometry of the interior space of the functional portion 706, thus providing close contact with the interior surfaces of the functional portion 706 to improve heat transfer. Although FIG. 7C illustrates a single inflatable heating element 712, in other embodiments, multiple inflatable heating elements 712 can be applied to different interior space of the functional portion 706 to produce localized heating. The number and arrangement of the inflatable heating elements 712 can be configured based on the geometry of the object 702.

Referring again to FIG. 3, the temperature gradient can be achieved using other heating techniques, as an alternative or in addition to the techniques illustrated in FIGS. 7B and 7C. For example, in some embodiments, the heating element is an energy source (e.g., a laser or IR source) that outputs energy having a wavelength that is absorbed by the material of the functional portion to heat the functional portion. In such embodiments, to avoid heating the support structures, the energy can be targeted to the functional portion, and/or the support structures can be made out of a different material that exhibits little or no absorption of the wavelength of energy. As another example, the heating element can be configured to apply a heated fluid (e.g., heated air or water) to the functional portion via jetting, spraying, blowing, and/or other suitable techniques. The heated fluid can be directed away from the support structures to avoid heating the support structures.

The heating process of block 306 can be performed before, during, and/or after the cooling process of block 304. For example, in some embodiments, the functional portion is heated while the support structures are simultaneously being cooled by a coolant (e.g., by immersion in a coolant as described in connection with FIGS. 6A and 6B). Alternatively or in combination, the functional portion can be “preheated” to a desired temperature before the support structures are cooled. This approach can ensure that the functional portion remains at a higher temperature than the support structures, even if the entire object is subsequently exposed to the coolant (e.g., by complete immersion as described above in connection with FIG. 6B). Alternatively or in combination, the functional portion can be “reheated” to a desired temperature after the support structures are cooled, thus producing a temperature gradient in the object even if the entire object was cooled (e.g., by complete immersion as described above in connection with FIG. 6B).

Optionally, the processes of blocks 304 and/or 306 can include thermally insulating the functional portion. For example, the functional portion can be thermally insulated from the coolant so that the coolant does not substantially cool the functional portion and/or so that any heat applied to the functional portion is not transferred to the coolant. In such embodiments, the functional portion can be thermally insulated by partially or completely covering the functional portion with a material having a low thermal conductivity.

Alternatively or in combination, the functional portion can be thermally insulated from the support structures such that the cooling of the support structures produces little or no cooling of the functional portion, and/or any heating of the functional portion produces little or no heating of the support structures. In such embodiments, the interface between the functional portion and the support structures can include a thermally insulative material to reduce or prevent heat transfer between the functional portion and the support structures.

At block 308, the method 300 can continue with fracturing the cooled support structures. The support structures can be fractured by applying a force to the object, such as manually, using an automated mechanism, or suitable combinations thereof. The force can be applied to the entire object (e.g., by shaking, tumbling, vibrating, sonicating, centrifuging), or can be applied to one or more selected portions of the object. For example, in some embodiments, the force is applied directly to the support structures, such as by brushing, cutting, scraping, peeling, jetting, blasting, abrading, sonicating, and/or otherwise breaking the support structures. As described above, the cooled support structures can be more susceptible to brittle fracture, such that less force is needed to fracture the cooled support structures compared to support structures that have not been cooled. For example, the amount of force needed to fracture the cooled support structures can be less than or equal to 90%, 80%, 70%, 60%, 50%, 40%, 30%, 20%, or 10% of the force need to fracture the support structures without cooling (e.g., at room temperature). Alternatively or in combination, the force can be applied directly to the functional portion of the object, rather than to the support structures. For example, the functional portion can be struck, tapped, vibrated, sonicated, etc., to produce internal forces that are transmitted to the support structures, thus causing the support structures to fracture. This approach can be used in embodiments where the geometry and/or material composition of the support structures produces increased stress concentration within the support structures when an impact is applied to the object (e.g., the embodiments of FIGS. 5A-5E).

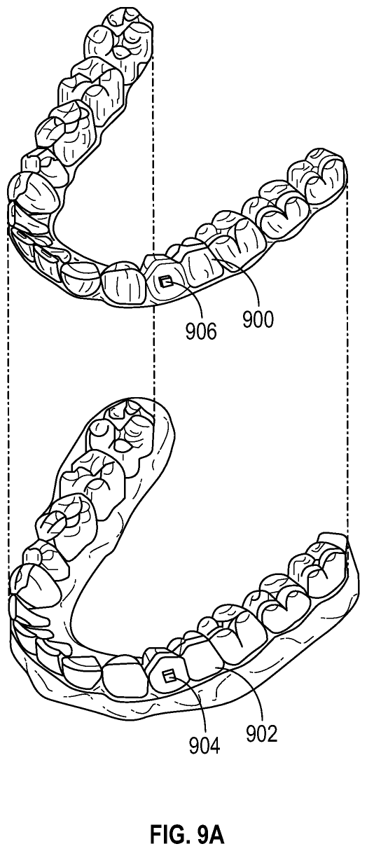

In some embodiments, the process of block 308 is performed after the cooling is finished and the support structures have been removed from the coolant. In such embodiments, the time period between the termination of cooling and the fracturing of the support structures can be sufficiently short so the support structures do not revert to their initial temperature and/or to ambient temperature. For example, the time period can be no more than 10 minutes, 5 minutes, 2 minutes, 1 minute, or 30 seconds. Alternatively, the process of block 308 can be performed while the support structures are being cooled, e.g., the force is applied while the support structures are still exposed to the coolant. A representative example of a system for concurrently cooling and fracturing the support structures of an object as described below with respect to FIG. 8.

The method 300 illustrated in FIG. 3 can be modified in many different ways. For example, although the above steps of the method 300 are described with respect to a single object, the method 300 can be used to sequentially or concurrently process any suitable number of objects, such as tens, hundreds, or thousands of additively manufactured objects. As another example, the ordering of the processes shown in FIG. 3 can be varied (e.g., the process of block 306 can be performed before or concurrently with the process of block 304, the process of block 308 can be performed concurrently with the processes of blocks 304 and/or 306). Some of the processes of the method 300 can be omitted, such as the process of block 306. In such embodiments, a temperature gradient (e.g., the temperature gradient shown in FIG. 7A) can be produced in the object without heating the functional portion, such as by protecting the functional portion from the coolant (e.g., using an insulating material and/or by avoiding direct exposure of the functional portion to the coolant). A temperature gradient can also be produced in the object due to the geometry and/or material properties of the object (e.g., the functional portion can be thicker than the support structures and can therefore cool more slowly, and/or the functional portion can be made out of a material that is less thermally conductive than the material of the support structures). Optionally, the method 300 can include cooling the entire object to substantially the same temperature, such that no temperature gradient is produced.

FIG. 8 is a partially schematic illustration of a system 800 for cooling an object 802, in accordance with embodiments of the present technology. The system 800 can be used to implement any of the methods described herein, such as the method 300 of FIG. 3.

The system 800 is configured to apply a coolant 804 onto the object 802 by jetting. As shown in FIG. 8, the system 800 includes a chamber 806 (e.g., a thermally insulated housing) configured to receive the object 802. The system 800 includes at least one applicator 808 (e.g., a nozzle) configured to direct a jet of the coolant 804 toward the object 802. The jet can be selectively targeted to the support structures 810 of the object 802 and away from the functional portion 812 of the object 802, as described further below. The applicator 808 can be coupled to a pump 814 that supplies the coolant 804. The pump 814 can be configured to output the jet of coolant 804 as a continuous stream, as a plurality of intermittent pulses, or suitable combinations thereof.

The application of the coolant 804 onto the support structures 810 can cool the support structures 810 to a desired temperature. Additionally, in some embodiments, the coolant 804 is pressurized so that the coolant 804 is jetted onto the support structures 810 at a sufficiently high pressure to fracture the support structures 810. For example, the pressure can be at least 50 psi, 60 psi, 70 psi, 80 psi, 90 psi, 100 psi, 125 psi, or 150 psi. Optionally, the jet of coolant 804 can include a plurality of solid particles (e.g., beads, shot, grit, powder) that are blasted onto the support structures 810 to facilitate breaking of the support structures 810. The particles can be made of a cryogenic material (e.g., dry ice) or can be made of a non-cryogenic material (e.g., glass, sand, ceramic, metal, polymer). In some embodiments, the coolant 804 includes a plurality of cryogenic particles (e.g., dry ice particles) that are combined with a non-cryogenic fluid (e.g., compressed air) to cool and fracture the support structures 810.

In some embodiments, the applicator 808 is stationary, such that the coolant 804 is applied to the object 802 from a single fixed direction. Alternatively, the applicator 808 can be movable (e.g., rotated and/or translated), such that the coolant 804 can be applied to the object 802 from different directions. Although FIG. 8 illustrates a single applicator 808, in other embodiments, the system 800 can include a plurality of applicators 808 (e.g., at least two, three, four, five, or more applicators 808) at different positions and/or orientations relative to the object 802. For example, any of the applicators 808 can be positioned at or near the upper portion of the chamber 806, the bottom portion of the chamber 806, or a sidewall of the chamber 806. In such embodiments, each of the applicators 808 can independently be fixed or movable. The use of a movable applicator 808 and/or multiple applicators 808 can make it easier to apply the coolant 804 to all of the support structures 810 of the object 802. Additionally, the use of a movable applicator 808 and/or multiple applicators 808 can allow the system 800 to accommodate objects 802 having different geometries (e.g., different arrangements of support structures 810).

As shown in FIG. 8, the object 802 can be supported by a carrier 816 (e.g., a frame, platform, clamp, holder, gripper, robotic arm). In the illustrated embodiment, the carrier 816 is coupled to the build platform 818 supporting the object 802. In other embodiments, however, the carrier 816 can be directly coupled to the object 802. The carrier 816 can be a stationary device, or can be a movable device that controls the position and/or orientation of the object 802 relative to the applicator 808. In some embodiments, the carrier 816 rotates and/or translates the object 802 so the support structures 810 are exposed to the jet of the coolant 804. Optionally, the carrier 816 can rotate and/or translate the object 802 to multiple poses so that the applicator 808 can sequentially apply the coolant 804 onto different subsets of the support structures 810. This approach can improve access to support structures 810 at different locations of the object 802, and can also allow the system 800 to be used with objects 802 with different geometries.

Optionally, the system 800 can include at least one sensor 820, such as a temperature sensor, position sensor, orientation sensor, motion sensor, optical sensor, imaging device, etc. For example, the sensor 820 can generate image data of the object 802, and the image data can be analyzed (e.g., using computer vision and/or machine learning algorithms) to identify the locations of the support structures 810 and the functional portion 812. Based on the location information, the jet of coolant 804 can be targeted to the support structures 810 while avoiding the functional portion 812. As another example, the sensor 820 can monitor a temperature of the object 802 (e.g., the temperature of the support structures 810 and/or functional portion 812) to ensure that the support structures 810 reach a desired cooling temperature and/or to avoid cooling the functional portion 812 below a predetermined threshold temperature.

The system 800 can include a controller 822 configured to control the operations of the other components of the system 800. For example, the controller 822 can be operably coupled to the applicator 808, pump 814, and/or carrier 816. The controller 822 can be or include a computing device including one or more processors and memory storing instructions for performing any of the following operations: controlling the application of the jet of coolant 804 delivered by the applicator 808 (e.g., with respect to rate, amount, timing, pulse frequency, pressure level); controlling the position and/or orientation of the applicator 808; controlling the position and/or orientation of the object 802 via the carrier 816; receiving and processing sensor data produced by the sensor 820; and/or using the sensor data as feedback for controlling the other components of the system 800.

In some embodiments, the controller 822 is configured to determine the locations of the support structures 810 in the object 802. The location information can be used to target the jet of the coolant 804 to the support structures 810 and away from the functional portion 812. e.g., by controlling the position and/or orientation of the applicator 808 and/or carrier 816. The locations of the support structures 810 can be determined in various ways. For example, the locations can be determined using sensor data obtained by the sensor 820, as described above. Alternatively or in combination, the locations of the support structures 810 can be determined using a digital representation of the object geometry (e.g., a 3D digital model of the object 802). In some embodiments, the digital representation is a digital file that is used to control an additive manufacturing system that fabricates the object 802, such as a CAD file, STI file, CLI file, toolpath file, or any other suitable file format that provides additive manufacturing instructions. The controller 822 can receive and process the digital representation in order to identify the locations of the support structures 810 in the digital representation.

Although the system 800 is depicted in connection with a single object 802, in other embodiments, the system 800 can be used to cool a plurality of objects 802, such as two, three, four, five, 10, 20, 30, 40, 50 or more objects 802. In such embodiments, one or more jets of the coolant 804 can be used to cool and fracture the support structures 810 of each object 802 sequentially. Alternatively, multiple jets of the coolant 804 can be used to cool and fracture the support structures 810 of multiple objects 802 simultaneously.

### III. Dental Appliances and Associated Methods

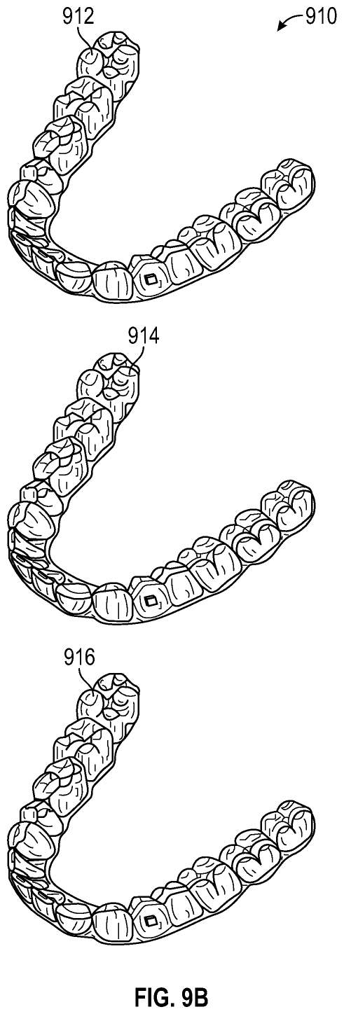

FIG. 9A illustrates a representative example of a tooth repositioning appliance 900 configured in accordance with embodiments of the present technology. The appliance 900 can be manufactured and post-processed using any of the systems, methods, and devices described herein. The appliance 900 (also referred to herein as an “aligner”) can be worn by a patient in order to achieve an incremental repositioning of individual teeth 902 in the jaw. The appliance 900 can include a shell (e.g., a continuous polymeric shell or a segmented shell) having teeth-receiving cavities that receive and resiliently reposition the teeth. The appliance 900 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 900 can fit over all teeth present in an upper or lower jaw, or less than all of the teeth. The appliance 900 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 900 can be a generic appliance configured to receive the teeth, but not necessarily shaped to match the topography of the patient's teeth. In some cases, only certain teeth received by the appliance 900 are repositioned by the appliance 900 while other teeth can provide a base or anchor region for holding the appliance 900 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 900 in place over the teeth. In some cases, however, it may be desirable or necessary to provide individual attachments 904 or other anchoring elements on teeth 902 with corresponding receptacles 906 or apertures in the appliance 900 so that the appliance 900 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 9B illustrates a tooth repositioning system 910 including a plurality of appliances 912, 914, 916, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 910 can include a first appliance 912 corresponding to an initial tooth arrangement, one or more intermediate appliances 914 corresponding to one or more intermediate arrangements, and a final appliance 916 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 9C illustrates a method 920 of orthodontic treatment using a plurality of appliances, in accordance with embodiments of the present technology. The method 920 can be practiced using any of the appliances or appliance sets described herein. In block 922, a first orthodontic appliance is applied to a patient's teeth in order to reposition the teeth from a first tooth arrangement to a second tooth arrangement. In block 924, a second orthodontic appliance is applied to the patient's teeth in order to reposition the teeth from the second tooth arrangement to a third tooth arrangement. The method 920 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

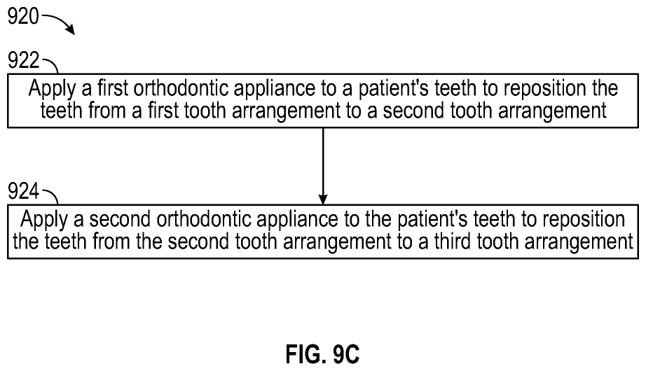

FIG. 10 illustrates a method 1000 for designing an orthodontic appliance, in accordance with embodiments of the present technology. The method 1000 can be applied to any embodiment of the orthodontic appliances described herein. Some or all of the steps of the method 1000 can be performed by any suitable data processing system or device, e.g., one or more processors configured with suitable instructions.

In block 1002, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1004, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1004 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1006, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1008, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1000 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1000 may be performed with any suitable fabrication system or device, such as the embodiments described herein. Some of the steps may be optional, e.g., the process of block 1004 can be omitted, such that the orthodontic appliance is designed based on the desired tooth movements and/or determined tooth movement path, rather than based on a force system. Moreover, the order of the steps can be varied as desired.

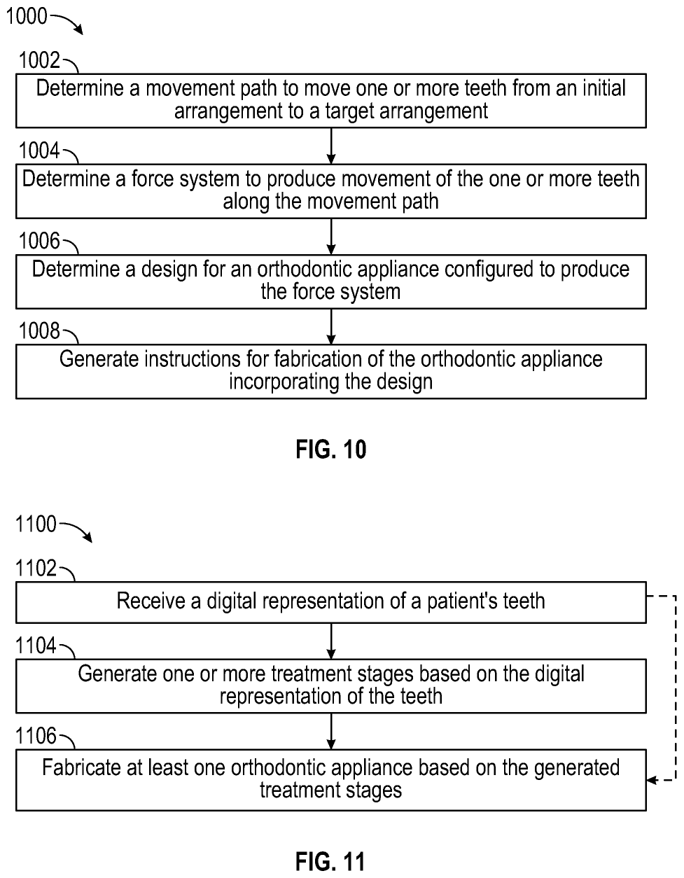

FIG. 11 illustrates a method 1100 for digitally planning an orthodontic treatment and/or design or fabrication of an appliance, in accordance with embodiments. The method 1100 can be applied to any of the treatment procedures described herein and can be performed by any suitable data processing system.

In block 1102, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1104, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1106, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 11, design and/or fabrication of an orthodontic appliance, and perhaps a particular orthodontic treatment, may include use of a representation of the patient's teeth (e.g., including receiving a digital representation of the patient's teeth (block 1102)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

1. A method comprising:
receiving an object fabricated using an additive manufacturing process, wherein the object comprises a functional portion and a plurality of support structures connecting the functional portion to a build platform;
cooling the plurality of support structures using a coolant; and
fracturing the plurality of support structures to separate the functional portion of the object from the build platform.

2. The method of Example 1, wherein the coolant comprises a cryogenic fluid, and wherein the cryogenic fluid comprises liquid nitrogen, sublimated dry ice, liquid carbon dioxide, liquid oxygen, or liquid helium.

3. The method of Example 1 or 2, wherein the plurality of support structures are cooled to a temperature within a range from 0° C. to −200° ° C.

4. The method of any one of Examples 1 to 3, wherein, after cooling, the plurality of support structures are more brittle than the functional portion of the object.

5. The method of any one of Examples 1 to 4, wherein each support structure comprises a narrowed region, and wherein fracturing the plurality of support structures comprises breaking the narrowed region of each support structure.

6. The method of Example 5, wherein the narrowed region exhibits a greater amount of stress than a remaining region of each support structure when a force is applied to the object.

7. The method of any one of Examples 1 to 6, wherein the plurality of support structures each comprise a material having a glass transition temperature, and the plurality of support structures are cooled to a temperature below the glass transition temperature.

8. The method of Example 7, wherein the functional portion of the object comprises the material having the glass transition temperature.

9. The method of Example 7, wherein the functional portion of the object comprises a second material having a second glass transition temperature lower than the glass transition temperature.

10. The method of any one of Examples 7 to 9, wherein the plurality of support structures each comprise:
a first region comprising the material having the glass transition temperature, and
a second region comprising a second material having a second glass transition temperature lower than the glass transition temperature.

11. The method of Example 10, wherein the first region is connected to the functional portion of the object, and the second region is spaced apart from the functional portion of the object.

12. The method of any one of Examples 1 to 11, wherein cooling the plurality of support structures comprises immersing the plurality of support structures in the coolant.

13. The method of Example 12, wherein the entire object is immersed in the coolant.

14. The method of Example 12, wherein the functional portion of the object is not immersed in the coolant.

15. The method of any one of Examples 11 to 14, further comprising removing the plurality of support structures from the coolant before fracturing the plurality of support structures.

16. The method of any one of Examples 1 to 11, wherein cooling the plurality of support structures comprises applying a jet of the coolant to the plurality of support structures.

17. The method of Example 16, wherein the jet is targeted to the plurality of support structures.

18. The method of Example 17, further comprising:
receiving sensor data indicating a location of the plurality of support structures, and
targeting the jet of the coolant to the plurality of support structures based on the sensor data.

19. The method of Example 17 or 18, further comprising:
receiving a digital representation of a geometry of the object, and
targeting the jet of the coolant to the plurality of support structures based on the digital representation.

20. The method of any one of Examples 16 to 19, wherein the plurality of support structures are fractured by the jet of the coolant.

21. The method of any one of Examples 1 to 20, further comprising generating a temperature gradient across the object.

22. The method of Example 21, wherein the temperature gradient comprises:
a first temperature at the plurality of support structures, and
a second temperature at the functional portion, wherein the second temperature is higher than the first temperature.

23. The method of Example 22, wherein generating the temperature gradient comprises heating the functional portion.

24. The method of Example 22 or 23, wherein generating the temperature gradient comprises exposing the plurality of support structures to the coolant while protecting the functional portion from the coolant.

25. The method of any one of Examples 1 to 24, wherein fracturing the plurality of support structures comprises applying a force to the plurality of support structures.

26. The method of any one of Examples 1 to 25, wherein fracturing the plurality of support structures comprises applying a force to the functional portion.

27. The method of Example 26, wherein the applied force produces stress concentration in the plurality of support structures.

28. The method of any one of Examples 1 to 27, wherein the functional portion comprises a dental appliance.

29. A system for processing an additively manufactured object, the system comprising:
a carrier configured to receive an object fabricated via an additive manufacturing process, wherein the object comprises a functional portion and a plurality of support structures;
an applicator configured to output a jet of a coolant;
a processor; and
memory comprising instructions that, when executed by the processor, cause the system to perform operations comprising:
   determining a location of the plurality of support structures, and
   applying the jet of the coolant to the plurality of support structures to cool the plurality of support structures.

30. The system of Example 29, wherein the coolant comprises a cryogenic fluid, and wherein the cryogenic fluid comprises liquid nitrogen, sublimated dry ice, liquid carbon dioxide, liquid oxygen, or liquid helium.

31. The system of Example 29 or 30, wherein the jet of the coolant is configured to cool the plurality of support structures to a temperature within a range from 0° C. to −200° C.

32. The system of any one of Examples 29 to 31, wherein the jet of the coolant is configured to fracture at least some of the plurality of support structures.

33. The system of any one of Examples 29 to 32, wherein the jet of the coolant is targeted toward the plurality of support structures and away from the functional portion.

34. The system of any one of Examples 29 to 33, wherein the applicator is movable.

35. The system of Example 34, wherein the operations further comprise moving the applicator to target the jet of the coolant to the plurality of support structures.

36 The system of any one of Examples 29 to 33, wherein the applicator is stationary.

37. The system of any one of Examples 29 to 36, wherein the carrier is movable.

38. The system of Example 37, wherein the operations further comprise moving the carrier so the jet of the coolant is targeted to the plurality of support structures.

39. The system of any one of Examples 29 to 36, wherein the carrier is stationary.

40. The system of any one of Examples 29 to 36, further comprising at least one sensor.

41. The system of Example 40, wherein the at least one sensor comprises a temperature sensor, and the operations further comprise applying the jet of the coolant until the plurality of support structures are cooled to a target temperature.

42. The system of Example 40 or 41, wherein the at least one sensor comprises an imaging device configured to generate image data of the object, and the location of the plurality of support structures is determined based on the image data.

43. The system of any one of Examples 29 to 42, wherein the operations further comprise receiving a digital representation of a geometry of the object, and wherein the location of the plurality of support structures is determined based on the digital representation.

44. The system of any one of Examples 29 to 43, further comprising at least one heating element configured to heat the functional portion of the object.

45. The system of Example 44, wherein the at least one heating element comprises a laser, an infrared energy source, or a source of heated fluid.

### CONCLUSION

Although many of the embodiments are described above with respect to systems, devices, and methods for processing dental appliances, the technology is applicable to other applications and/or other approaches, such as processing of other types of additively manufactured objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-11.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method comprising:
receiving an object fabricated using an additive manufacturing process, wherein the object comprises a functional portion and a plurality of support structures connecting the functional portion to a build platform, and wherein the functional portion comprises a dental appliance;
cooling the plurality of support structures using a coolant; and
fracturing the plurality of support structures to separate the functional portion of the object from the build platform.

2. The method of claim 1, wherein the coolant comprises a cryogenic fluid, and wherein the cryogenic fluid comprises liquid nitrogen, sublimated dry ice, liquid carbon dioxide, liquid oxygen, or liquid helium.

3. The method of claim 1, wherein the plurality of support structures are cooled to a temperature within a range from 0° C. to −200° C.

4. The method of claim 1, wherein, after cooling, the plurality of support structures are more brittle than the functional portion of the object.

5. The method of claim 1, wherein each support structure comprises a narrowed region, and wherein fracturing the plurality of support structures comprises breaking the narrowed region of each support structure.

6. The method of claim 1, wherein the plurality of support structures each comprise a material having a glass transition temperature, and the plurality of support structures are cooled to a temperature below the glass transition temperature.

7. The method of claim 1, wherein cooling the plurality of support structures comprises immersing the plurality of support structures in the coolant.

8. The method of claim 7, wherein the entire object is immersed in the coolant.

9. The method of claim 7, wherein the functional portion of the object is not immersed in the coolant.

10. The method of claim 7, further comprising removing the plurality of support structures from the coolant before fracturing the plurality of support structures.

11. The method of claim 1, wherein cooling the plurality of support structures comprises applying a jet of the coolant to the plurality of support structures.

12. The method of claim 11, further comprising:
receiving sensor data indicating a location of the plurality of support structures, and
targeting the jet of the coolant to the plurality of support structures based on the sensor data.

13. The method of claim 11, further comprising:
receiving a digital representation of a geometry of the object, and
targeting the jet of the coolant to the plurality of support structures based on the digital representation.

14. The method of claim 1, further comprising generating a temperature gradient across the object.

15. The method of claim 14, wherein the temperature gradient comprises:
a first temperature at the plurality of support structures, and
a second temperature at the functional portion, wherein the second temperature is higher than the first temperature.

16. The method of claim 14, wherein generating the temperature gradient comprises heating the functional portion.

17. The method of claim 14, wherein generating the temperature gradient comprises exposing the plurality of support structures to the coolant while protecting the functional portion from the coolant.

18. The method of claim 1, wherein fracturing the plurality of support structures comprises applying a force to the plurality of support structures.

19. The method of claim 1, wherein fracturing the plurality of support structures comprises applying a force to the functional portion.

20. The method of claim 1, wherein the dental appliance is an aligner, a palatal expander, a retainer, or an attachment placement device.
